(19) United States
(12) Patent Application Publication
(10) Pub. No.: US 2008/0056766 A1
(43) Pub. Date: Mar. 6, 2008

(54) Conductive foamed roller, method of producing the same, and image forming apparatus

(75) Inventor: Satoru Furuya, Tokyo (JP)

Correspondence Address: TAKEUCHI & KUBOTERA, LLP, SUITE 202, 200 DAINGERFIELD ROAD, ALEXANDRIA, VA, 22314, US

(73) Assignee: Oki Data Corporation

(21) Appl. No.: 11/892,472

(22) Filed: Aug. 23, 2007

(30) Foreign Application Priority Data
Aug. 31, 2006 (JP) 2006-235642

(51) Int. Cl. G03G 15/02; C22C 1/00

(52) U.S. Cl. 399/176; 148/95

(57) ABSTRACT

A conductive foamed roller includes a metal shaft portion and a conductive foamed rubber portion. The conductive foamed roller has a permanent compressive strain of equal to or less than 1.75%.

### BACKGROUND OF THE INVENTION

The present invention relates to a conductive foamed roller, a method of producing the conductive foamed roller, and an image forming apparatus.

In a conventional image forming apparatus such as a printer, a copier, a fax machine, and a multifunction machine thereof, a charging roller and a transfer roller contacting with a photosensitive drum while rotating are formed of a conductive foamed roller (refer to Patent Reference).

### Patent Reference; Japanese Patent Publication No. 09-114186

When the conductive foamed roller stays contacting with an adjacent member for a long period of time, a rubber causes a permanent deformation at a contact position thereof. In this case, it is difficult to obtain an image with high quality.

In view of the problem described above, an object of the invention is to provide a conductive foamed roller and an image forming apparatus, in which it is easy to prevent a permanent deformation. Another object of the invention is to provide a method of producing the conductive foamed roller.

Further objects and advantages of the invention will be apparent from the following description of the invention.

### SUMMARY OF THE INVENTION

In order to attain the objects described above, according to a first aspect of the present invention, a conductive foamed roller includes a metal shaft portion and a conductive foamed rubber portion. The conductive foamed roller has a permanent compressive strain of equal to or less than 1.75%.

According to a second aspect of the present invention, a method of producing a conductive foamed roller having a metal shaft portion and a conductive foamed rubber portion includes the steps of: mixing an acrylonitrile butadiene rubber in a first amount and an epichlorohydrin rubber in a second amount smaller than the first amount to obtain a rubber mixture; extruding the rubber mixture into a hollow tube; cutting the hollow tube to obtain a preliminary mold tube; performing a first vulcanization process on the preliminary mold tube; inserting a metal shaft portion into the preliminary mold tube to obtain a first mold roller; performing a second vulcanization process on the first mold roller at a specific temperature for a specific period of time; and grinding the first mold roller in a specific shape.

According to a third aspect of the present invention, a method of producing a conductive foamed roller having a metal shaft portion and a conductive foamed rubber portion includes the steps of: mixing an acrylonitrile butadiene rubber in a first amount and an epichlorohydrin rubber in a second amount smaller than the first amount to obtain a rubber mixture; extruding the rubber mixture into a hollow tube; cutting the hollow tube to obtain a preliminary mold tube; performing a first vulcanization process on the preliminary mold tube; inserting a metal shaft portion into the preliminary mold tube to obtain a first mold roller; performing a second vulcanization process on the first mold roller; grinding the first mold roller in a specific shape to obtain a second mold roller; and annealing the second mold roller at a specific temperature for a specific period of time.

According to a fourth aspect of the present invention, a conductive foamed roller is produced with the method according to the second aspect or the third aspect of the present invention. The conductive foamed roller includes a rubber portion having an outer diameter gradually decreasing from a center portion thereof toward an end portion thereof.

According to a fifth aspect of the present invention, an image forming apparatus includes a photosensitive drum for supporting a toner image; and a transfer roller directly or indirectly pressed against the photosensitive drum for applying a voltage so that the toner image is transferred to a recording medium. The transfer roller is formed of the conductive foamed roller in one of the first to fourth aspects of the present invention.

In the present invention, the vulcanized rubber is foamed in a sponge state. The rubber mixture contains a large amount of the acrylonitrile butadiene rubber for providing flexibility and a small amount of the epichlorohydrin rubber for reducing environmental load. It is possible to reduce permanent compressive deformation or a permanent compressive strain, thereby preventing a lateral stream in an image and improving print quality.

### BRIEF DESCRIPTION OF THE DRAWINGS

FIG. 1 is a schematic view showing an image forming apparatus according to a first embodiment of the present invention;

FIG. 2 is a schematic view showing a transfer roller disposed in the image forming apparatus according to the present invention;

FIG. 3 is a schematic view showing a method of measuring an electrical resistivity of a conductive foamed roller;

FIG. 4 is a schematic view showing a method of measuring a permanent compressive strain of the conductive foamed roller;

FIG. 5 is a schematic front view showing a conductive foamed roller having an ideal outer circumferential surface according to a third embodiment of the present invention;

FIG. 6 is a schematic view showing a conductive foamed roller having an approximate shape relative to the ideal shape shown in FIG. 5;

FIGS. 7(a) and 7(b) are graphs showing radius profiles of the conductive foamed roller shown in FIG. 6;

FIG. 8 is a schematic front view showing a conductive foamed roller having an ideal outer circumferential surface according to a fourth embodiment of the present invention;

FIG. 9 is a schematic view showing a conductive foamed roller having an approximate shape relative to the ideal shape shown in FIG. 8;

FIG. 10 is a graph showing a radius profile of the conductive foamed roller shown in FIG. 9;

FIG. 11 is a schematic view showing another conductive foamed roller having an approximate shape relative to the ideal shape shown in FIG. 8;

FIG. 12 is a graph showing a radius profile of a conductive foamed roller having two types of conical trapezoid portions without a column portion;

FIG. 13 is a graph showing a radius profile of a conductive foamed roller having the conical portions arranged at ideal positions;

FIG. 14 is a graph showing a radius profile of an outer diameter of the conductive foamed roller approximated from that shown in FIG. 11;

FIG. 15 is a graph showing a profile of an outer diameter of a conductive foamed roller ground with the conductive foamed roller shown in FIG. 7(b) as a target;

FIG. 16 is a graph showing a profile of an outer diameter of a conductive foamed roller ground with the conductive foamed roller shown in FIG. 10 as a target;

FIG. 17 is a graph showing a profile of an outer diameter of a conductive foamed roller ground with the conductive foamed roller shown in FIG. 14 as a target;

FIG. 18 is a graph showing a profile of a nip amount of the conductive foamed roller shown in FIG. 9 with respect to a photosensitive drum; and

FIG. 19 is a graph showing a profile of a nip amount of the conductive foamed roller shown in FIG. 11 with respect to the photosensitive drum.

### DETAILED DESCRIPTION OF PREFERRED EMBODIMENTS

Hereunder, embodiments of the present invention will be explained with reference to the accompanying drawings.

### First Embodiment

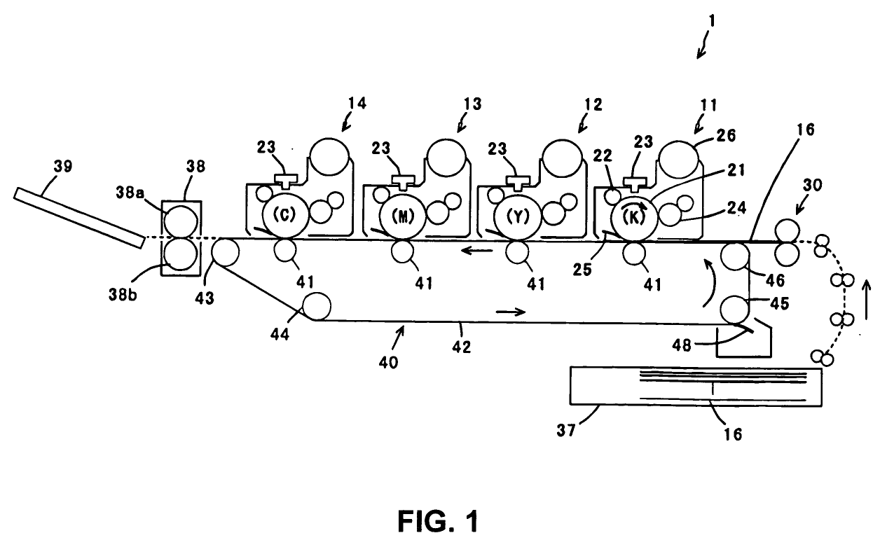

A first embodiment of the present invention will be explained. FIG. 1 is a schematic view showing an image forming apparatus 1 according to the first embodiment of the present invention. The image forming apparatus 1 has a configuration of a color electric-photography printer capable of printing an image in four colors, i.e., black (K), yellow (Y), magenta (M), and cyan (C).

As shown in FIG. 1, in the image forming apparatus 1, four image drum units 11 to 14 are disposed along a transport path of a recording sheet 16 as a recording medium in this order from an upstream side of the transport path, so that the image drum units 11 to 14 form images in black (K), yellow (Y), magenta (M), and cyan (C). A sheet supply cassette 37 is disposed at a lower portion of the image forming apparatus 1 for retaining the recording sheet 16 in a stacked state, so that the recording sheet 16 is picked up one by one.

In the embodiment, a sheet supply roller (not shown) is disposed at an end portion of the sheet supply cassette 37 in a pick-up direction for separating and picking up the recording sheet 16 one by one from the sheet supply cassette 37. Along the transport path of the recording sheet 16 (partially indicated with a hidden line), there are disposed in this order from the upstream side a resister roller unit 30 for transporting the recording sheet 16 while correcting skew thereof; a transport belt 42 as an endless member for transporting the recording sheet 16; the image drum units 11 to 14 arranged along the transport belt 42; a fixing unit 38 having a heating member such as a halogen lamp for heating and pressing the recording sheet 16 so that developer is fixed to the recording sheet 16; and a discharge tray 39 for storing the recording sheet 16 discharged.

In the embodiment, each of the image drum units 11 to 14 includes an LED head 23 for forming a static latent image, thereby forming toner images in black (K), yellow (Y), magenta (M), and cyan (C). The image drum units 11 to 14 have an identical configuration, except using different colors of toner, i.e., toner of black (K), yellow (Y), magenta (M), and cyan (C). In the following description, an internal configuration of the image drum unit 11 of black (K) will be explained in detail.

In the embodiment, the image drum unit 11 includes a photosensitive drum 21 for supporting the toner image; a charging roller 22 for charging a surface of the photosensitive drum 21; the LED head 23 for forming the static latent image on the surface of the photosensitive drum 21 thus charged; a developing roller 24 for forming the toner image from the static latent image through frictional charging; a cleaning blade 25 for removing toner remaining on the surface of the photosensitive drum 21; and a toner cartridge 26 for storing and supplying toner in block (K).

In the embodiment, a transfer unit 40 includes the transfer belt 42 for statically attaching and transporting the recording sheet 16; a drive roller 43 driven with a drive unit (not shown) for driving the transport belt 42; tension rollers 44 to 46 for applying tension to the transport belt 42 together with the drive roller 43; transfer rollers 41 facing and pressed against the photosensitive drums 21 of the image drum units 11 to 14 for applying a voltage so that the toner images are transferred to the recording sheet 16; and a cleaning blade 48 for removing toner attached to the transport belt 42.

In the embodiment, the image drum units 11 to 14 are driven in sync with the transport belt 42, so that the toner images in colors statically attached to the transport belt 42 are sequentially transferred to the recording sheet 16. After the toner images are transferred to the recording sheet 16 at the image drum units 11 to 14 and the transfer unit 40, the recording sheet 16 is transported to the fixing unit 38, so that the toner images are fixed to the recording sheet 16 through heat and pressure.

In the embodiment, the fixing unit 38 includes a pair of rollers, i.e., an upper roller 38a having a heating source (not shown) therein and a lower roller 38b coated with an elastic member. After the toner images are transferred to the recording sheet 16, the fixing unit 38 applies heat and pressure to the toner images on the recording sheet 16, so that the toner images are fixed to the recording sheet 16. Afterward, a discharge roller unit (not shown) discharges the recording sheet 16 to the discharge tray 39.

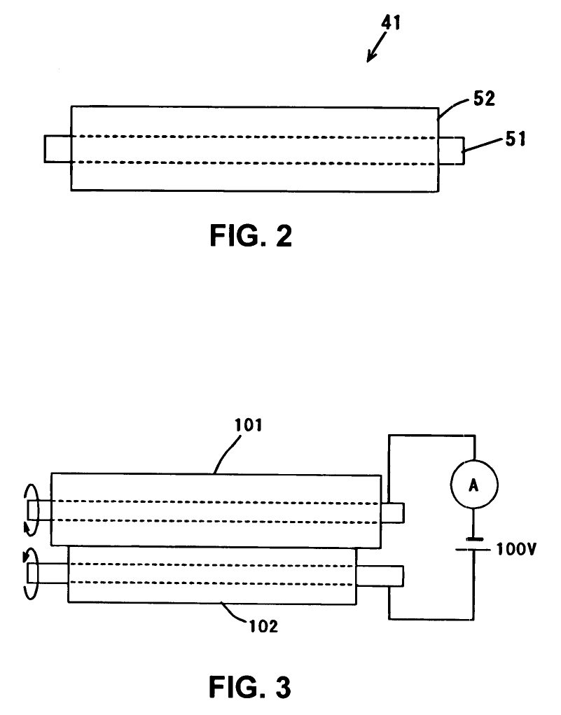

FIG. 2 is a schematic view showing the transfer roller 41 disposed in the image forming apparatus 1 according to the present invention.

As shown in FIG. 2, the transfer roller 41 is a conductive foamed roller having electric conductivity with a desired resistivity, and includes a metal shaft portion 51 with a column shape and a foamed rubber layer 52 coaxially laminated on a circumferential surface of the metal shaft portion 51. A rubber portion of the transfer roller 41 is formed of a mixture of an acrylonitrile butadiene rubber and an epichlorohydrin rubber (described later). The rubber mixture may contain a vulcanization agent, a vulcanization promoting agent, a vulcanization promoting supporting agent, a foaming agent, an acid scavenging agent; a filler; and the likes (described later)

In the embodiment, the transfer roller 41 is preferably provided with ASKER C hardness of less than 45° for obtaining a large contact width with respect to an object to be contacted. Accordingly, a rubber portion or the foamed rubber layer 52 is formed of a foamed material having sufficient flexibility. Further, the transfer roller 41 is preferably provided with ASKER C hardness of greater than 25° for obtaining a proper pressing force for transfer.

In the embodiment, the rubber portion or the foamed rubber layer 52 of the transfer roller 41 is preferably provided with a proper electric resistivity. When the rubber portion or the foamed rubber layer 52 of the transfer roller 41 has a resistivity of smaller than 10⁵ Ω·cm, it is difficult to transfer an image to an object having a large volume resistivity. When the rubber portion or the foamed rubber layer 52 of the transfer roller 41 has a resistivity of greater than 10¹⁰ Ω·cm, it is difficult to generate a sufficient transfer current due to a large load to a power source.

Accordingly, the rubber portion or the foamed rubber layer 52 of the transfer roller 41 is preferably provided with a resistivity in a range of 10⁵ Ω·cm to 10¹⁰ Ω·cm. In the specification, the range is called a medium resistivity range. When the rubber portion or the foamed rubber layer 52 of the transfer roller 41 is formed of an epichlorohydrin rubber, it is possible to stably obtain the medium resistivity range due to inherent electric conductivity of the epichlorohydrin rubber.

In the embodiment, the rubber portion of the transfer roller 41 is formed of a rubber mixture containing a vulcanization agent, a vulcanization promoting agent, a vulcanization promoting supporting agent, a foaming agent, an acid scavenging agent; and a filler. The vulcanization agent may include a sulfur type vulcanization agent, i.e., a vulcanization agent for a nitrile rubber, such as sulfur powder, an organic sulfur containing compound, a peroxide surfer, and the likes. The organic sulfur containing compound may include tetramethyl-thiuram-disulfide, N,N-dithio-bis-morpholine, and the likes. The peroxide surfer may include benzoyl-peroxide and the likes. A triazine type vulcanization agent, i.e., a vulcanization agent for an epichlorohydrin rubber, may include 2,4,6-trimercapto-S-triazine, 2-substitute-4,6-dimrcapto-S-triazine (substitute including an alkyl group, alkyl-amino group, a dialkyl-amino group, and the likes), and the likes.

In the embodiment, the vulcanization promoting agent may include a thio-urea type vulcanization promoting agent, a triazine derivative, and the likes. The thio-urea type vulcanization promoting agent may include tetramethyl-thiourea, trimethyl-thiourea, ethylene-thiourea, (CₙH₂ₙ₊₁NH)₂C═S (n is an integer from 1 to 10), and the likes.

In the embodiment, the vulcanization promoting supporting agent may include zinc oxide, magnesium oxide, calcium hydrate, zinc carbonate, stearic acid, and the likes.

In the embodiment, the foaming agent may include an organic foaming agent such as azodicarvone-amide (ADCA), 4,4′-oxybis-benzenesulfonyl-hydrazide (OBSH), and a mixture thereof. A chemical foaming agent may include N,N-nitrospentamethylene-tetramine (DPT) and the likes.

In the embodiment, the acid scavenging agent may include magnesium oxide, magnesium hydrate, magnesium carbonate, calcium carbonate, calcium silicate, calcium stearate, zinc stearate, zinc oxide, tin oxide, a hydrotalcite-type compound, and the likes.

In the embodiment, the filler may include powder of silica, carbon black, talc, calcium carbonate, dobasic phosphite (DLP), basic magnesium carbonate, alumina, and the likes.

An experiment of producing and evaluating the conductive foamed rollers used as the transfer roller 41 and the charging roller 22 will be explained next. In the experiment, the conductive foamed rollers were produced under various conditions. Then, the conductive foamed rollers thus produced were evaluated in terms of an electric resistivity, a circumferential resistivity variance, and a product hardness.

Table 1 shows raw materials for producing the Conductive foamed rollers and compositions (composition A, composition B, composition C) thereof. Table 2 shows details of polymers (acrylonitrile butadiene rubber (NBR), epichlorohydrin rubber).

TABLE 1

| | | Composition | Composition | Compo- |
|---|---|---|---|---|
| Raw Material | | A | B | sition C |
| NBR | Polymer | 55 | 70 | 85 |
| Epichlorohydrin | Polymer | 45 | 30 | 15 |
| rubber | | | | |
| Hydrotalcite- | Acid | 3 | 3 | 3 |
| type compound | scavenging | | | |
| | agent | | | |
| Azodicarvone- | Foaming agent | 3 | 3 | 3 |
| amide | | | | |
| Benzenesulfonyl- | Foaming agent | 3 | 3 | 3 |
| hydrazide | | | | |
| Sulfur powder | Vulcanization | 1 | 1 | 1 |
| | agent | | | |
| Tetramethyl- | Vulcanization | 1 | 1 | 1 |
| thiourea | promoting | | | |
| | agent | | | |
| Ethylene- | Vulcanization | 1 | 1 | 1 |
| thiourea | promoting | | | |
| | agent | | | |

TABLE 2

| Polymer | Product name | Manufacture |
|---|---|---|
| NBR | Nipol DN 401LL | Nippon Zeon |
| Epichlorohydrin | CG102 | Daiso |
| rubber | | |

In the experiment, first, a rubber mixture having the composition B was kneaded in a sealed kneader (DS10-40MWA-S, product of Moriyama Seisakusho) at 100° C. for 10 minutes. The rubber mixture was taken out from the sealed kneader in a ribbon shape, and was introduced into a single screw extruder maintained at 40° C., thereby extruding the rubber mixture into a hollow tube shape having an outer diameter of 16 mm, an inner diameter of 5 mm, and a length of 30 m.

Afterward, the rubber tube was cut in preliminary mold tubes having a specific length. The preliminary mold tubes were placed in a vulcanization vessel of pressure steam type in a first vulcanization process, so that the preliminary mold tubes were vulcanized at 160° C. for 60 minutes. In the first vulcanization process, the foaming agent was converted to a gas state for foaming, and rubber components were vulcanized.

In the next step, a metal shaft portion formed of a metal shaft with an outer diameter of 6.0 mm was coated with a hotmelt adhesive. Then, the metal shaft portion was fitted into a hollow portion of the foamed tube with a cylindrical shape thus vulcanized, thereby obtaining a first mold roller.

In the next step, the first mold roller was placed in a convection oven under conditions shown in Table 3 in a second vulcanization process. After the conductive foamed rubber was integrated with the metal shaft portion, both end portions were cut, so that a total length of the rubber portion became 214 mm. Then, a surface of the rubber portion was ground, so that the rubber portion had a thickness of 4.0 mm and an outer diameter of 14.0 mm.

With respect to Examples No. 1 to No. 10 of the conductive foamed rollers, the electric resistivity, the circumferential resistivity variance, and the product hardness were measured, and results thereof are shown in Table 3. Further, a strain amount, a strain, and a solid printing image were measured and evaluated, and results thereof are shown in Table 4.

TABLE 3
Composition B

| | Example | Example | Example | Example | Example |
|---|---|---|---|---|---|
| | No. 1 | No. 2 | No. 3 | No. 4 | No. 5 |
| Temperature (° C.) | 110 | 110 | 110 | 130 | 130 |
| Time (hr) | 1.0 | 3.0 | 5.0 | 1.0 | 3.0 |
| Electric resistivity (Ω) | 5.06E+07 | 5.54E+07 | 5.73E+07 | 5.51E+07 | 6.03E+07 |
| Circumferential | 1.1 | 1.1 | 1.1 | 1.1 | 1.1 |
| resistivity variance | | | | | |
| Product hardness (Asker C) | 38 | 38 | 36 | 38 | 38 |
| | Example | Example | Example | Example | Example |
| | No. 6 | No. 7 | No. 8 | No. 9 | No. 10 |
| Temperature (° C.) | 130 | 140 | 140 | 140 | 160 |
| Time (hr) | 5.0 | 1.0 | 3.0 | 5.0 | 1.0 |
| Electric resistivity (Ω) | 6.59E+07 | 5.36E+07 | 6.58E+07 | 7.42E+07 | 6.17E+07 |
| Circumferential | 1.1 | 1.1 | 1.1 | 1.1 | 1.1 |
| resistivity variance | | | | | |
| Product hardness (Asker C) | 40 | 37 | 39 | 40 | 39 |

TABLE 4

| | Example | Example | Example | Example | Example |
|---|---|---|---|---|---|
| | No. 1 | No. 2 | No. 3 | No. 4 | No. 5 |
| Strain | 0.070 | 0.061 | 0.067 | 0.069 | 0.062 |
| amount | | | | | |
| (mm) | | | | | |
| Strain (%) | 1.74 | 1.53 | 1.68 | 1.72 | 1.54 |
| Solid | Good | Good | Good | Good | Good |
| printing | | | | | |
| image | | | | | |
| | Example | Example | Example | Example | Example |
| | No. 6 | No. 7 | No. 8 | No. 9 | No. 10 |
| Strain | 0.069 | 0.066 | 0.070 | 0.066 | 0.084 |
| amount | | | | | |
| (mm) | | | | | |
| Strain (%) | 1.72 | 1.65 | 1.75 | 1.64 | 2.09 |
| Solid | Good | Good | Good | Good | Poor |
| printing | | | | | |
| image | | | | | |

A method of measuring the electric resistivity, the circumferential resistivity variance, and the product hardness will be explained next. Further, a method of measuring the permanent compressive strain, and evaluating the solid printing image will be explained next.

FIG. 3 is a schematic view showing the method of measuring the electrical resistivity of a conductive foamed roller 102. As shown in FIG. 3, the conductive foamed roller 102 (specimen) was arranged to abut against a rotational drum 101 formed of a metal, so that the conductive foamed roller 102 rotated with the rotational drum 101. A direct current of 1,000 V was applied to the conductive foamed roller 102 and the rotational drum 101 under a temperature of 20° C. and a humidity of 50%. A current flowing through the conductive foamed roller 102 was measured, and the electric resistivity was calculated from an average of the current.

In measuring the circumferential resistivity variance, a maximum value and a minimum value of the electric resistivity were measured along a circumference of the conductive foamed roller 102. A ratio of the maximum value to the minimum value was defined as the circumferential resistivity variance.

In measuring the product hardness, an ASKER C hardness meter was pressed against the circumference of the conductive foamed roller 102 with a load of 1,000 gf.

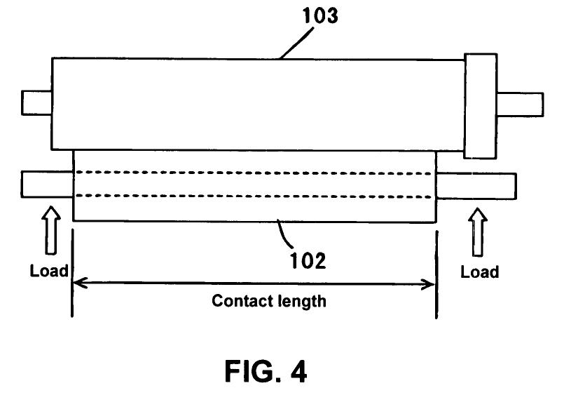

FIG. 4 is a schematic view showing a method of measuring a permanent compressive strain of the conductive foamed roller 102. As shown in FIG. 4, the conductive foamed roller 102 was pressed against a cylindrical member 103 with an outer diameter of 30 mm with a pressing force of 47 gf/cm. The conductive foamed roller 102 corresponds to a transfer roller, and the cylindrical member 103 corresponds to a photosensitive drum. In this state, the conductive foamed roller 102 and the cylindrical member 103 were placed under a temperature of 70° C. and a humidity of 90% for seven days.

In the measurement, the pressing force was defined as a total load divided by a contact length. In a case of an A4 size, the contact length was 214 mm, and the total load was 1,000 gf. A spring and the like urged a center axis of the conductive foamed roller 102, so that the conductive foamed roller 102 was pressed against the cylindrical member 103.

After the conductive foamed roller 102 and the cylindrical member 103 were placed under a temperature of 70° C. and a humidity of 90% for seven days, the total load was released. Then, after seven days from releasing the total load, remaining strains of the rubber portion were measured at a center point and both end points from both ends by 10 mm along a longitudinal direction (axial direction of the metal shaft portion). The permanent compressive strain (%) was defined as an average of the remaining strains divided by a thickness of the rubber.

In evaluating the solid printing image, the conductive foamed roller 102 was disposed as the transfer roller 41 in, for example, the image forming apparatus 1 shown in FIG. 1. Then, the image forming apparatus 1 printed an image pattern with 100% for evaluating image quality. The conductive foamed roller 102 as the transfer roller 41 was pressed against the photosensitive drum 21 with a constant load, i.e., the total load of 1,000 gf.

When the conductive foamed roller 102 exhibited the permanent compressive strain greater than a specific level, it was difficult to properly press the conductive foamed roller 102 against the photosensitive drum 21. Accordingly, it was difficult to transfer toner, thereby causing a lateral streak in an image. The solid printing image was evaluated based on a lateral streak in an image.

As shown in Table 3 and Table 4, when the conductive foamed roller 102 exhibited the permanent compressive strain smaller than 1.75% in Examples No. 1 to No. 9, it was possible to obtain a good image without a lateral streak. On the other hand, when the conductive foamed roller 102 exhibited the permanent compressive strain of 2.09%, greater than a specific level, in Example No. 10, the resultant image with 100% showed a lateral streak.

Accordingly, as shown in Examples No. 1 to No. 9, when the conductive foamed roller 102 was vulcanized in the second vulcanization step under a specific temperature and a specific humidity to have the permanent compressive strain smaller than 1.75%, it was possible to prevent a lateral streak from generating in an image. It is preferred that the permanent compressive strain is as small as possible. In practical use, it is suffice that the permanent compressive strain is smaller than 1.75%.

When a rubber mixture contains a large amount of an acrylonitrile butadiene rubber, a foamed and vulcanized rubber of the rubber mixture tends to exhibit a high permanent compressive strain.

According to the method of producing the conductive foamed roller in the embodiment, even when a rubber mixture contains a large amount of the acrylonitrile butadiene rubber and a small amount of the epichlorohydrin rubber for reducing environmental load, it is possible to minimize the permanent compressive strain under a specific level after foaming a vulcanized rubber to provide flexibility, thereby preventing a lateral stream due to the permanent compressive strain and improving print quality.

### Second Embodiment

A second embodiment of the present invention will be explained next. In an experiment using the composition A shown in Table 1, the conductive foamed rollers were produced according to Examples No. 11 to No. 17 shown in Table 5.

In the experiment, first, a rubber mixture having the composition A was kneaded in the sealed kneader (DS10-40MWA-S, product of Moriyama Seisakusho) at 100° C. for 10 minutes. The rubber mixture was taken out from the sealed kneader in a ribbon shape, and was introduced into the single screw extruder maintained at 40° C., thereby extruding the rubber mixture into a hollow tube shape having an outer diameter of 16 mm, an inner diameter of 5 mm, and a length of 30 m.

Afterward, the rubber tube was cut in preliminary mold tubes having a specific length. The preliminary mold tubes were placed in a vulcanization vessel of pressure steam type in the first vulcanization process, so that the preliminary mold tubes were vulcanized at 160° C. for 60 minutes. In the first vulcanization process, the foaming agent was converted to a gas state for foaming, and rubber components were vulcanized.

In the next step, a metal shaft portion formed of a metal shaft with an outer diameter of 6.0 mm was coated with a hotmelt adhesive. Then, the metal shaft portion was fitted into a hollow portion of the foamed tube with a cylindrical shape thus vulcanized, thereby obtaining a first mold roller.

In the next step, the first mold roller was placed in a convection oven at 160° C. for 60 minutes in the second vulcanization process. After the conductive foamed rubber was integrated with the metal shaft portion, both end portions were cut, so that a total length of the rubber portion became 214 mm. Then, a surface of the rubber portion was ground, thereby obtaining a second mold roller having a rubber thickness of 4.0 mm and an outer diameter of 14.0 mm.

In the next step, the second mold roller was placed in a convection oven under conditions shown in Table 5 in an annealing process, thereby obtaining Examples No. 11 to No. 17 of the conductive foamed rollers.

With respect to Examples No. 11 to No. 17 of the conductive foamed rollers, the electric resistivity, the circumferential resistivity variance, and the product hardness were measured, and results thereof are shown in Table 5. Further, the strain amount, the strain, and the solid printing image were measured and evaluated, and results thereof are shown in Table 6.

The method of measuring the electric resistivity, the circumferential resistivity variance, and the product hardness are the same as those in the first embodiment, and explanation thereof are omitted. Further, the method of measuring the permanent compressive strain, and evaluating the solid printing image are the same as those in the first embodiment, and explanation thereof are omitted.

TABLE 5
Composition A

| | Example | Example | Example | Example | Example |
|---|---|---|---|---|---|
| | No. 11 | No. 12 | No. 13 | No. 14 | No. 15 |
| Temperature (° C.) | None | 70 | 90 | 110 | 130 |
| Time (hr) | None | 168 | 42 | 10.5 | 2.63 |
| Electric resistivity (Ω) | 1.66E+07 | 2.18E+07 | 2.21E+07 | 2.10E+07 | 1.97E+07 |
| Circumferential | 1.07 | 1.11 | 1.06 | 1.07 | 1.09 |
| resistivity variance | | | | | |
| Product hardness (Asker C) | 36 | 37 | 37 | 38 | 37 |

| | Example | Example |
|---|---|---|
| | No. 16 | No. 17 |
| Temperature (° C.) | 140 | 150 |
| Time (hr) | 1.32 | 0.66 |
| Electric resistivity (Ω) | 2.01E+07 | 1.91E+07 |
| Circumferential | 1.07 | 1.08 |
| resistivity variance | | |
| Product hardness (Asker C) | 37 | 36 |

TABLE 6

| | Example | Example | Example | Example | Example |
|---|---|---|---|---|---|
| | No. 11 | No. 12 | No. 13 | No. 14 | No. 15 |
| Strain | 0.079 | 0.065 | 0.062 | 0.065 | 0.057 |
| amount | | | | | |
| (mm) | | | | | |
| Strain (%) | 1.98 | 1.63 | 1.55 | 1.63 | 1.43 |
| Solid | Poor | Good | Good | Good | Good |
| printing | | | | | |
| image | | | | | |

| | Example | Example |
|---|---|---|
| | No. 16 | No. 17 |
| Strain amount | 0.062 | 0.076 |
| (mm) | | |
| Strain (%) | 1.55 | 1.90 |
| Solid printing | Good | Poor |
| image | | |

As shown in Table 6, when the conductive foamed roller exhibited the permanent compressive strain smaller than 1.63% in Examples No. 12 to No. 16, it was possible to obtain a good image without a lateral streak. On the other hand, when the conductive foamed roller exhibited the permanent compressive strain of 1.98% or 1.90% in Example No. 11 or No. 17, the resultant image with 100% showed a lateral streak.

Accordingly, as shown in Examples No. 12 to No. 16, when the conductive foamed roller was annealed in the annealing process under a specific temperature and a specific humidity to have the permanent compressive strain smaller than 1.63%, it was possible to prevent a lateral streak from generating in an image.

In another experiment using the composition B shown in Table 1, the conductive foamed rollers were produced according to Examples No. 18 to No. 23 shown in Table 7.

In the experiment, similar to Examples No. 11 to No. 17, a rubber mixture having the composition A was kneaded at 100° C. for 10 minutes. The rubber mixture was extruded into a hollow tube shape having. Afterward, the rubber tube was cut in preliminary mold tubes. The preliminary mold tubes were vulcanized at 160° C. for 60 minutes in the first vulcanization process, and were further vulcanized at 160° C. for 60 minutes in the second vulcanization process, thereby obtaining the second mold roller.

In the next step, the second mold roller was placed in a convection oven under conditions shown in Table 7 in the annealing process, thereby obtaining Examples No. 18 to No. 23 of the conductive foamed rollers.

With respect to Examples No. 18 to No. 23 of the conductive foamed rollers, the electric resistivity, the circumferential resistivity variance, and the product hardness were measured, and results thereof are shown in Table 7. Further, the strain amount, the strain, and the solid printing image were measured and evaluated, and results thereof are shown in Table 8.

TABLE 7
Composition B

| | Example | Example | Example | Example | Example | Example |
|---|---|---|---|---|---|---|
| | No. 18 | No. 19 | No. 20 | No. 21 | No. 22 | No. 23 |
| Temperature | None | 70 | 90 | 110 | 130 | 150 |
| (° C.) | | | | | | |
| Time (hr) | None | 168 | 42 | 10.5 | 2.63 | 2.66 |
| Electric | 4.48E+07 | 5.68E+07 | 5.94E+07 | 5.28E+07 | 5.44E+07 | 4.97E+07 |
| resistivity (Ω) | | | | | | |
| Circumferential | 1.11 | 1.06 | 1.07 | 1.07 | 1.11 | 1.08 |
| resistivity variance | | | | | | |
| Product | 36 | 38 | 39 | 39 | 38 | 37 |
| hardness (Asker C) | | | | | | |

TABLE 8

| | Example | Example | Example | Example | Example | Example |
|---|---|---|---|---|---|---|
| | No. 18 | No. 19 | No. 20 | No. 21 | No. 22 | No. 23 |
| Strain | 0.077 | 0.063 | 0.061 | 0.057 | 0.055 | 0.075 |
| amount (mm) | | | | | | |
| Strain (%) | 1.92 | 1.58 | 1.52 | 1.42 | 1.38 | 1.88 |
| Solid | Poor | Good | Good | Good | Good | Poor |
| printing | | | | | | |
| image | | | | | | |

As shown in Table 8, when the conductive foamed roller exhibited the permanent compressive strain smaller than 1.58% in Examples No. 19 to No. 22, it was possible to obtain a good image without a lateral streak. On the other hand, when the conductive foamed roller exhibited the permanent compressive strain of 1.92% or 1.88% in Example No. 18 or No. 23, the resultant image with 100% showed a lateral streak.

Accordingly, as shown in Examples No. 19 to No. 22, when the conductive foamed roller was annealed in the annealing process under a specific temperature and a specific humidity to have the permanent compressive strain smaller than 1.58%, it was possible to prevent a lateral streak from generating in an image.

In a further experiment using the composition C shown in Table 1, the conductive foamed rollers were produced according to Examples No. 24 to No. 29 shown in Table 9.

In the experiment, similar to Examples No. 11 to No. 17, a rubber mixture having the composition C was kneaded at 100° C. for 10 minutes. The rubber mixture was extruded into a hollow tube shape having. Afterward, the rubber tube was cut in preliminary mold tubes. The preliminary mold tubes were vulcanized at 160° C. for 60 minutes in the first vulcanization process, and were further vulcanized at 160° C. for 60 minutes in the second vulcanization process, thereby obtaining the second mold roller.

In the next step, the second mold roller was placed in a convection oven under conditions shown in Table 9 in the annealing process, thereby obtaining Examples No. 24 to No. 29 of the conductive foamed rollers.

With respect to Examples No. 24 to No. 29 of the conductive foamed rollers, the electric resistivity, the circumferential resistivity variance, and the product hardness were measured, and results thereof are shown in Table 9. Further, the strain amount, the strain, and the solid printing image were measured and evaluated, and results thereof are shown in Table 10.

TABLE 9
Composition C

| | Example | Example | Example | Example | Example | Example |
|---|---|---|---|---|---|---|
| | No. 24 | No. 25 | No. 26 | No. 27 | No. 28 | No. 29 |
| Temperature | None | 70 | 90 | 110 | 130 | 150 |
| (° C.) | | | | | | |
| Time (hr) | None | 168 | 42 | 10.5 | 2.63 | 0.66 |
| Electric | 8.13E+07 | 1.07E+07 | 1.08E+07 | 1.04E+07 | 9.50E+07 | 9.38E+07 |
| resistivity (Ω) | | | | | | |
| Circumferential | 1.10 | 1.12 | 1.09 | 1.11 | 1.09 | 1.10 |
| resistivity variance | | | | | | |
| Product | 37 | 38 | 39 | 38 | 38 | 37 |
| hardness (Asker C) | | | | | | |

TABLE 10

| | Example | Example | Example | Example | Example | Example |
|---|---|---|---|---|---|---|
| | No. 24 | No. 25 | No. 26 | No. 27 | No. 28 | No. 29 |
| Strain | 0.076 | 0.060 | 0.062 | 0.054 | 0.056 | 0.075 |
| amount (mm) | | | | | | |
| Strain (%) | 1.90 | 1.50 | 1.55 | 1.35 | 1.40 | 1.88 |
| Solid | Poor | Good | Good | Good | Good | Poor |
| printing image | | | | | | |

As shown in Table 10, when the conductive foamed roller exhibited the permanent compressive strain smaller than 1.55% in Examples No. 25 to No. 28, it was possible to obtain a good image without a lateral streak. On the other hand, when the conductive foamed roller exhibited the permanent compressive strain of 1.90% or 1.88% in Example No. 24 or No. 29, the resultant image with 100% showed a lateral streak.

Accordingly, as shown in Examples No. 25 to No. 28, when the conductive foamed roller was annealed in the annealing process under a specific temperature and a specific humidity to have the permanent compressive strain smaller than 1.55%, it was possible to prevent a lateral streak from generating in an image.

As described above, according to the method of producing the conductive foamed roller in the embodiment, even when a rubber mixture contains a large amount of the acrylonitrile butadiene rubber and a small amount of the epichlorohydrin rubber for reducing environmental load, it is possible to minimize the permanent compressive strain under a specific level after foaming a vulcanized rubber to provide flexibility, thereby preventing a lateral stream due to the permanent compressive strain and improving print quality.

Further, as compared with the first embodiment, it is possible to further reduce the permanent strain, i.e., less than 1.63% as shown in Examples described above, thereby improving quality and productivity.

### Third Embodiment

A third embodiment of the present invention will be explained next. In an experiment, Example No. 5 of the conductive foamed roller in the first embodiment was ground to have a specific outer diameter, thereby obtaining Example No. 30 of the conductive foamed roller.

First, similar to Examples No. 1 to No. 10, the first mold roller was obtained, and the first mold roller was placed in a convection oven at 130° C. for 3 hours in the second vulcanization process, similar to Example No. 5 shown in Table 3. After the conductive foamed rubber was integrated with the metal shaft portion, both end portions were cut, so that a total length of the rubber portion became 214 mm. Then, a surface of the rubber portion was ground, thereby obtaining a conductive foamed roller having a rubber thickness of 4.0 to 4.1 mm. Further, the conductive foamed roller had a drum shape having an outer diameter of 14.0 mm at both end portions thereof and an outer diameter of 14.1 mm at a center portion thereby, i.e., an outer diameter difference of 100 μm.

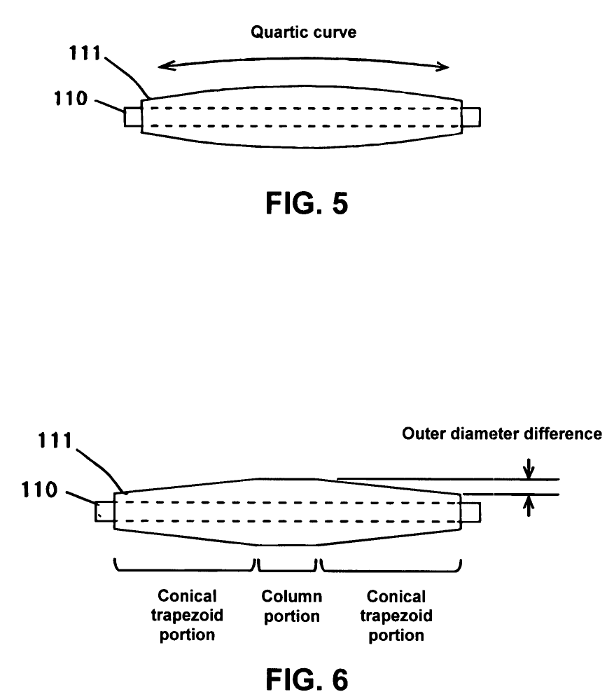

FIG. 5 is a schematic front view showing a conductive foamed roller having an ideal outer circumferential surface according to the third embodiment of the present invention. As shown in FIG. 5, the conductive foamed roller has a metal shaft portion 110 and a rubber portion 111. The rubber portion 111 has a sectional contour extending along a quartic curve, so that an outer circumferential surface has a drum shape.

FIG. 6 is a schematic view showing a conductive foamed roller having an approximate shape relative to the ideal shape shown in FIG. 5. As shown in FIG. 6, the conductive foamed roller has a center portion having a column shape and both end portions having a conical shape.

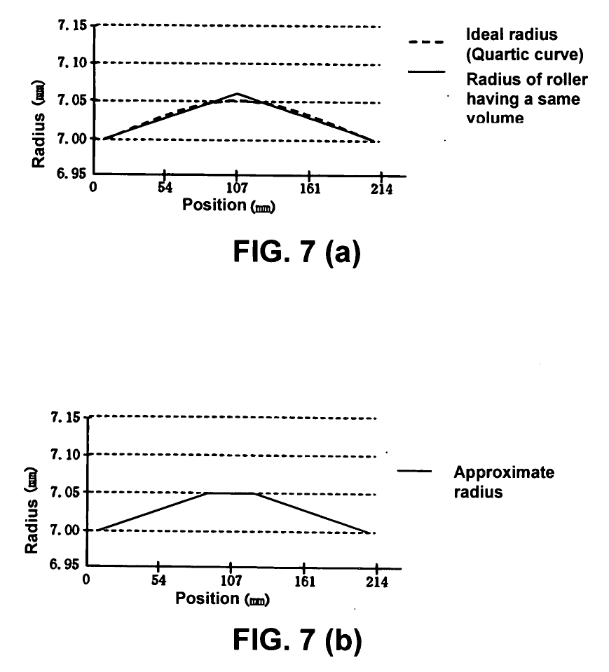

FIGS. 7(a) and 7(b) are graphs showing radius profiles of the conductive foamed roller shown in FIG. 6. As shown in FIG. 7(a), a radius profile having a trapezoid shape was selected, so that a rubber portion having the radius profile had a volume same as that of the rubber portion having the ideal shape. Then, a portion of the conductive foamed roller having a radius exceeding 7.05 mm was ground to obtain the conductive foamed roller having a radius profile shown in FIG. 7(b).

FIG. 15 is a graph showing a profile of an outer diameter of a conductive foamed roller ground with the conductive foamed roller shown in FIG. 7(b) as a target. Through the process described above, the conductive foamed roller having an outer diameter difference of 90 μm was obtained.

With respect to Example No. 30 of the conductive foamed roller, the strain amount, the strain, and the solid printing image were measured and evaluated, and results thereof are shown in Table 11.

The method of measuring the permanent compressive strain, and evaluating the solid printing image are the same as those in the first embodiment, and explanation thereof are omitted.

TABLE 11

| | Example |
|---|---|
| | No. 30 |
| Strain amount | 0.053 |
| (mm) | |
| Strain (%) | 1.32 |
| Solid printing | Good |
| image | |

As shown in Table 11, the conductive foamed roller exhibited the permanent compressive strain of 1.32%, and it was possible to obtain a good image.

As shown in FIG. 15, the outer diameter of the conductive foamed roller was slightly deviated from the ideal profile at portions of the conductive foamed roller within less than 10 mm from the end portions thereof. In grinding the conductive foamed roller, it was difficult to grind the end portions thereof as designed due to deformation of the rubber portion caused by non-compressive property of rubber. In an actual use, the end portions of the rubber portion tend to deform outside relative to an object to be contacted. Accordingly, the deviation from the ideal profile at the portions of the conductive foamed roller within less than 10 mm from the end portions thereof is insignificant.

As described above, in the experiment, when the conductive foamed roller with the permanent compressive strain of 1.54% (Example No. 5 in Table 3 and Table 4) was ground to have the drum shape, the resultant conductive foamed roller (Example No. 30) exhibited the permanent compressive strain of 1.32%. Accordingly, when the rubber portion of the conductive roller was formed in a drum shape, it was possible to reduce the permanent compressive strain.

### Fourth Embodiment

A fourth embodiment of the present invention will be explained next. In an experiment, Examples No. 31 and No. 32 of the conductive foamed rollers were produced using the composition B shown in Table 1.

In the experiment, first, a rubber mixture having the composition B was kneaded in the sealed kneader (DS10-40MWA-S, product of Moriyama Seisakusho) at 100° C. for 10 minutes. The rubber mixture was taken out from the sealed kneader in a ribbon shape, and was introduced into the single screw extruder maintained at 40° C., thereby extruding the rubber mixture into a hollow tube shape having an outer diameter of 20 mm, an inner diameter of 7 mm, and a length of 30 m.

Afterward, the rubber tube was cut in preliminary mold tubes having a specific length. The preliminary mold tubes were placed in a vulcanization vessel of pressure steam type in the first vulcanization process, so that the preliminary mold tubes were vulcanized at 160° C. for 60 minutes. In the first vulcanization process, the foaming agent was converted to a gas state for foaming, and rubber components were vulcanized.

In the next step, a metal shaft portion formed of a metal shaft with an outer diameter of 8.0 mm was coated with a hotmelt adhesive. Then, the metal shaft portion was fitted into a hollow portion of the foamed tube with a cylindrical shape thus vulcanized, thereby obtaining a first mold roller.

In the next step, the first mold roller was placed in a convection oven at 130° C. for 3 hours in the second vulcanization process. After the conductive foamed rubber was integrated with the metal shaft portion, both end portions were cut, so that a total length of the rubber portion became 301 mm corresponding to an A3 size. Then, a surface of the rubber portion was ground, thereby obtaining the conductive foamed roller. The conductive foamed roller had a drum shape having an outer diameter of 16.0 mm at both end portions thereof and an outer diameter of 16.2 mm at a center portion thereby, i.e., an outer diameter difference of 200 μm.

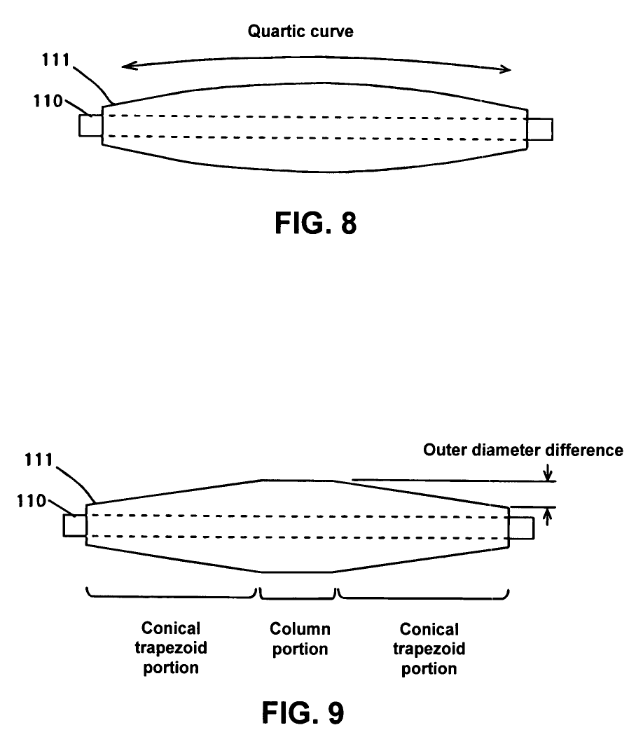

FIG. 8 is a schematic front view showing a conductive foamed roller having an ideal outer circumferential surface according to the fourth embodiment of the present invention. As shown in FIG. 8, the conductive foamed roller has the metal shaft portion 110 and the rubber portion 111. The rubber portion 111 has a sectional contour extending along a quartic curve, so that an outer circumferential surface has a drum shape.

FIG. 9 is a schematic view showing a conductive foamed roller having an approximate shape relative to the ideal shape shown in FIG. 8. As shown in FIG. 9, the conductive foamed roller (Example No. 31) has a center portion having a column shape and both end portions having a conical shape.

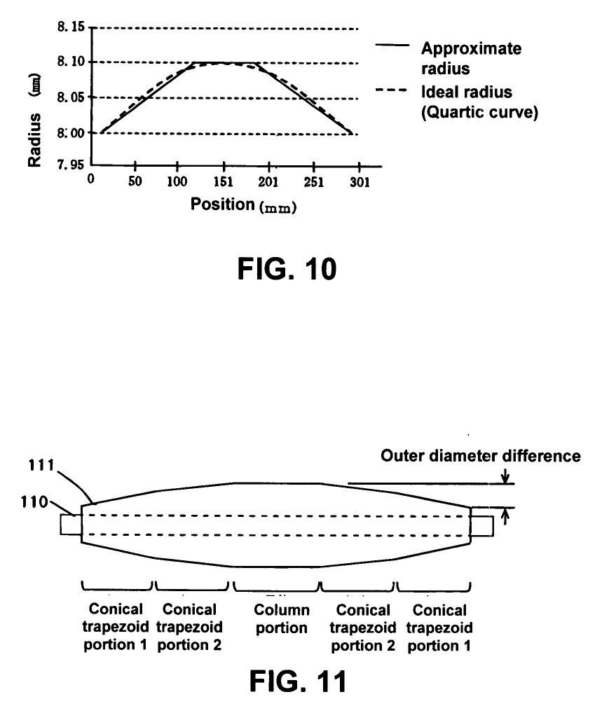

FIG. 10 is a graph showing a radius profile of the conductive foamed roller shown in FIG. 9. Similar to Example No. 30 in the third embodiment, a radius profile having a trapezoid shape was selected, so that a rubber portion having the radius profile had a volume same as that of the rubber portion having the ideal shape. Then, a portion of the conductive foamed roller having a radius exceeding 8.10 mm was ground to obtain the conductive foamed roller having the radius profile shown in FIG. 10.

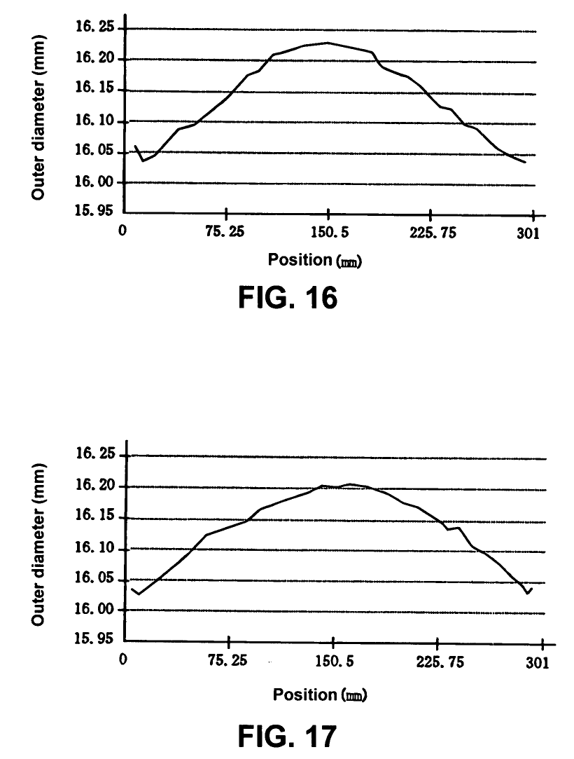

FIG. 16 is a graph showing a profile of an outer diameter of a conductive foamed roller ground with the conductive foamed roller shown in FIG. 10 as a target. Through the process described above, the conductive foamed roller having an outer diameter difference of 186 μm was obtained.

With respect to Example No. 31 of the conductive foamed roller, the strain amount, the strain, and the solid printing image were measured and evaluated, and results thereof are shown in Table 12.

As shown in Table 12, Example No. 31 of the conductive foamed roller exhibited the permanent compressive strain of 1.80%, and it was not possible to obtain a good image.

TABLE 12

| | Example | Example |
|---|---|---|
| | No. 31 | No. 32 |
| Strain amount | 0.072 | 0.062 |
| (mm) | | |
| Strain (%) | 1.80 | 1.55 |
| Solid printing | Poor | Good |
| image | | |

FIG. 11 is a schematic view showing another conductive foamed roller (Example No. 32) having an approximate shape relative to the ideal shape shown in FIG. 8. As shown in FIG. 11, the conductive foamed roller has the metal shaft portion 110 and the rubber portion 111. The rubber portion 111 has symmetrical left and right portions with respect to a center portion thereof along an axial direction of the metal shaft portion 110.

Further, the rubber portion 111 has a center portion having a column shape, and two types of conical trapezoid portions 1 and 2 are smoothly connected without a step and extend from the center portion toward both end portions of the rubber portion 111. It is preferred that a boundary between the conical trapezoid portions 1 and 2 is situated in an area between 10 mm inside from the end portion and 28% of a total length of the rubber portion inside from the end portion (described later).

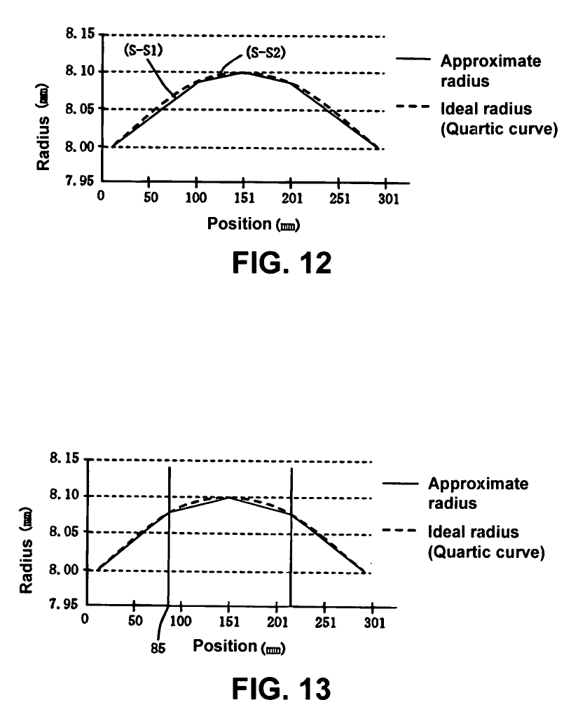

FIG. 12 is a graph showing a radius profile of a conductive foamed roller having the two types of conical trapezoid portions 1 and 2 without the column portion. In order to optimize a conical trapezoid portion with respect to the ideal shape base on the quartic curve, a boundary position is determined, so that a volume difference, i.e., (S-S1)+(S-S2) in FIG. 12, is minimized. That is, a boundary position satisfies the following variational function.

Δ((S-S1)+(S-S2))=MIN (minimum value)

It was determined that the boundary position was located 85 mm inside from the end portion. FIG. 13 is a graph showing a radius profile of the conductive foamed roller having the conical portions arranged at the ideal positions, in which the boundary is located 85 mm, corresponding about 28% of the total length (301 mm), inside from the end portion.

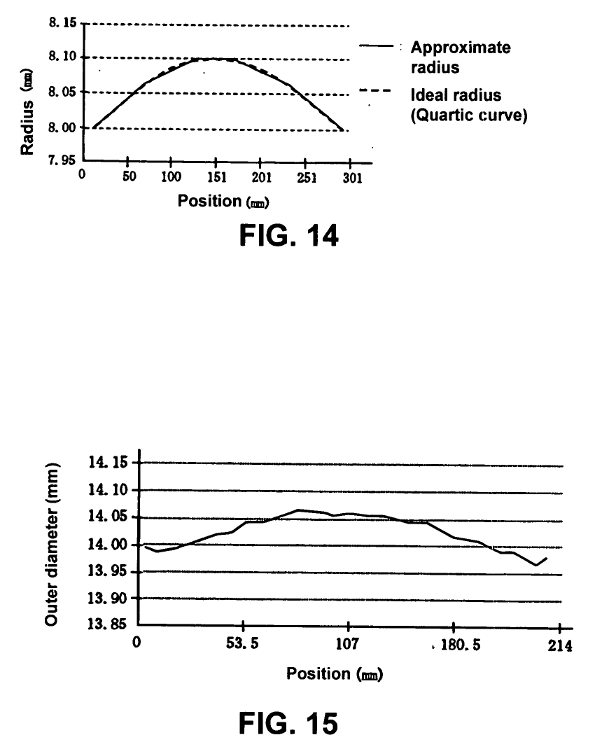

When the conductive foamed roller has the column portion, the boundary is shifted toward the end portion. Accordingly, it is preferred that the boundary is situated within 28% of the total length of the rubber portion inside from the end portion. FIG. 14 is a graph showing a radius profile of an outer diameter of the conductive foamed roller approximated from that shown in FIG. 11.

FIG. 17 is a graph showing a profile of an outer diameter of a conductive foamed roller (Example No. 32) ground with the conductive foamed roller shown in FIG. 14 as a target. As shown in FIG. 17, the conductive foamed roller has an outer diameter difference of 180 μm. The conductive foamed roller shown in FIG. 17 shows a deviation from the ideal profile at portions of the conductive foamed roller within less than 10 mm from the end portions thereof. As explained above, the deviation is insignificant.

As shown in Table 12, Example No. 32 of the conductive foamed roller exhibited the permanent compressive strain of 1.55%, and it was possible to obtain a good image.

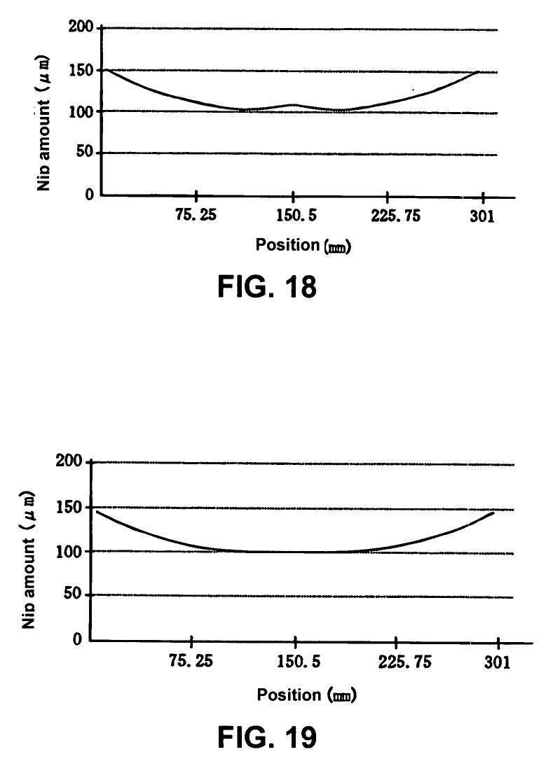

FIG. 18 is a graph showing a profile of a nip amount of the conductive foamed roller (Example No. 31) shown in FIG. 9 with respect to the photosensitive drum 21 or the cylindrical member 103 corresponding to the photosensitive drum 21 in FIG. 1. FIG. 19 is a graph showing a profile of a nip amount of the conductive foamed roller shown in FIG. 11 with respect to the photosensitive drum 21 or the cylindrical member 103.

As shown in FIG. 18, the conductive foamed roller (Example No. 31) received relatively large load at the end portions thereof, relatively small load at portions near the center portion thereof, and slightly large load at the center portion thereof. That is, the conductive foamed roller (Example No. 31) had the total length extended for dealing with the A3 size, so that the tapered shape did not exhibit sufficient effect.

As shown in FIG. 19, the conductive foamed roller (Example No. 32) received load at the end portions thereof not as concentrated as the conductive foamed roller (Example No. 31) shown in FIG. 18, thereby reducing the permanent strain. The conductive foamed roller (Example No. 32) had the two types of conical trapezoid portions to approximate the quartic curve, and preferably has more conical trapezoid portions to reduce a volume difference with respective to the quartic curve.

As described above, in the conductive foamed roller in the embodiment, the rubber portion has a plurality of conical trapezoid portions extending smoothly without a step portion to approximate the quartic curve, thereby reducing the permanent strain. Accordingly, when the conductive foamed roller the total length extended for dealing with the A3 size, it is possible to provide the conductive foamed roller capable of reducing the permanent strain.

The disclosure of Japanese Patent Applications No. 2006-235642, filed on Aug. 31, 2006, is incorporated in the application by reference.

While the invention has been explained with reference to the specific embodiments of the invention, the explanation is illustrative and the invention is limited only by the appended claims.

What is claimed is:

1. A conductive foamed roller comprising,
a metal shaft portion; and
a conductive foamed rubber portion, said conductive foamed roller having a permanent compressive strain of equal to or less than 1.75%.

2. The conductive foamed roller according to claim 1, wherein said conductive foamed roller has the permanent compressive strain of equal to or less than 1.63%.

3. The conductive foamed roller according to claim 1, wherein said conductive foamed rubber portion is formed of a mixture of an acrylonitrile butadiene rubber and an epichlorohydrin rubber.

4. The conductive foamed roller according to claim 1, wherein said conductive foamed rubber portion is formed of a mixture of an acrylonitrile butadiene rubber in a first amount and an epichlorohydrin rubber in a second amount smaller than the first amount.

5. The conductive foamed roller according to claim 1, wherein said conductive foamed rubber portion includes a portion having an outer diameter gradually decreasing from a center portion of the conductive foamed rubber portion to an end portion thereof along an axial direction of the metal shaft portion.

6. The conductive foamed roller according to claim 1, wherein said conductive foamed rubber portion includes symmetrical left and right portions symmetrical to with each other with respect to a center portion of the conductive foamed rubber portion along an axial direction of the metal shaft portion, at least one of said symmetrical left and right portions including a plurality of conical trapezoid portions having different shapes.

7. The conductive foamed roller according to claim 6, wherein at least one of said symmetrical left and right portions includes a first conical trapezoid portion and a second conical trapezoid portion with a boundary therebetween, said boundary being situated within an area of 28% of a total length of the conductive foamed rubber portion inside from an end portion of the conductive foamed rubber portion.

8. A method of producing a conductive foamed roller, comprising the steps of:
mixing an acrylonitrile butadiene rubber in a first amount and an epichlorohydrin rubber in a second amount smaller than the first amount to obtain a rubber mixture;
extruding the rubber mixture into a hollow tube;
cutting the hollow tube to obtain a preliminary mold tube;
performing a first vulcanization process on the preliminary mold tube;
inserting a metal shaft portion into the preliminary mold tube to obtain a first mold roller;
performing a second vulcanization process on the first mold roller at a specific temperature for a specific period of time; and
grinding the first mold roller in a specific shape to obtain a second mold roller.

9. The method of producing a conductive foamed roller according to claim 8, wherein, in the step of performing the second vulcanization process, the second vulcanization process is performed at a range of 110° C. to 140° C. for a range of one hour to five hours.

10. The method of producing a conductive foamed roller according to claim 8, further comprising the step of annealing the second mold roller at a specific temperature for a specific period of time.

11. The method of producing a conductive foamed roller according to claim 10, wherein, in the step of annealing the second mold roller, the second mold roller is annealed at a range of 70° C. to 140° C. for a range of 1.32 hours to 168 hours.

12. A conductive foamed roller produced by the method according to claim 8.

13. An image forming apparatus comprising a photosensitive drum for supporting a toner image; and a transfer roller directly or indirectly pressed against the photosensitive drum for applying a voltage so that the toner image is transferred to a recording medium, said transfer roller being formed of the conductive foamed roller according to claim 1.

14. An image forming apparatus comprising a photosensitive drum for supporting a toner image; and a transfer roller directly or indirectly pressed against the photosensitive drum for applying a voltage so that the toner image is transferred to a recording medium, said transfer roller being formed of the conductive foamed roller according to claim 12.

15. An image forming apparatus comprising a photosensitive drum for supporting a toner image; and a transfer roller directly or indirectly pressed against the photosensitive drum for applying a voltage so that the toner image is transferred to a recording medium, said transfer roller being formed of the conductive foamed roller produced by the method according to claim 8.
